(19) United States
(12) Patent Application Publication
(10) Pub. No.: US 2011/0205086 A1
(43) Pub. Date: Aug. 25, 2011

(54) Traffic Control System and Method

(75) Inventors: Gerhard Lamprecht, Cape Town (ZA); Brendon Farren Bentley, Cape Town (ZA)

(73) Assignee: TMT SERVICES AND SUPPLIES (PTY) LIMITED, Cape Town, Western Cape Province (ZA)

(21) Appl. No.: 12/996,943

(22) PCT Filed: Jun. 15, 2009
(86) PCT No.: PCT/IB09/05941

§ 371 Date: Mar. 2, 2011

(30) Foreign Application Priority Data
Jun. 13, 2008 (ZA) 2008/05175

(51) Int. Cl. G08G 1/065; G08G 1/095

(52) U.S. Cl. 340/928

(57) ABSTRACT

A traffic control system is provided including an arrangement of traffic lights at a traffic intersection, and a radar sensor installed at the intersection such that its field and range of detection covers at least one approach to the intersection. The radar sensor is adapted to sense the presence of vehicles within a predetermined field of view and range. A controller for switching the traffic lights is operated by an electronic processor utilizing information developed from data inputted from the radar sensor. The radar sensor is a multi-object radar sensor capable of developing data from which the location, speed, acceleration or deceleration, and direction of travel of each vehicle within its field and range of detection can be derived.

### FIELD OF THE INVENTION

This invention relates to a traffic control system and method for controlling the flow of traffic at intersections at which traffic lights are installed for the purpose of regulating the flow of traffic travelling in different directions. The term “traffic” as used in this specification mostly refers to vehicular traffic but, where appropriate, it should be widely construed to include pedestrian traffic as well.

### BACKGROUND TO THE INVENTION

Many conventional road traffic intersection controllers employ presence detectors to sense the presence of a vehicle. The most significant two limitations of such presence detectors are that they can only sense a vehicle at the specific location where the detector is installed and even if a plurality of such detectors are installed along the road in an attempt to overcome that limitation, the progress of a particular vehicle cannot be followed in the presence of other vehicles. Of course, separate detectors are required for at least each direction of approach to an intersection if any useful information is to be generated and the cost of multiple installations is expensive and disruptive to traffic during the installation procedure. The most common type of presence detector is the inductive loop detector but many other forms of presence detectors can be used.

Added to this is the difficulty that such conventional intersection controllers, because of their basic detection drawbacks, use statistical traffic modelling in an attempt to infer the traffic conditions from the sparse data gathered from the presence detectors. Such statistical modelling has a tendency to become inefficient under dense or slow moving traffic conditions. The consequence of this is that when the intersection controller is required to optimize traffic flow most, such a controller performs at its worst.

In the case of pedestrian traffic, pedestrians are often required to press manual vehicular traffic interruption buttons when they wish to cross busy intersections. These button activated circuits are intended to interrupt the normal control of traffic lights to allow for pedestrians to cross an intersection. The buttons and the circuits that they activate are, however, often worn out or defective, thereby not operating properly and making it increasingly difficult and potentially dangerous for pedestrians to cross the relevant intersections whilst often unnecessarily or excessively interrupting traffic flow.

Traffic video cameras, on the other hand, are dependent on good visibility and cannot effectively tolerate conditions of poor visibility. This is particularly unsatisfactory, as conditions of poor visibility generally lead to slower moving traffic that normally requires improved management. Another disadvantage of traffic video camera detection is that range estimation deteriorates as the distance between the camera and the target increases.

Of course, there are also many traffic light controlled intersections at which no presence detectors are installed and wherein the operation of the traffic lights is carried out purely on a timed basis and often on a basis that varies according to the time of day or week. In such instances a driver may be stopped by a red traffic light for an appreciable period of time totally unnecessarily in the absence of any other traffic passing through the intersection. This not only results in a waste of fuel consumed and causes excessive pollution whilst a vehicle is stationary but is, possibly more seriously, also a waste of the time of the driver concerned or a waste of available time of a commercial vehicle that can diminish the utilisation of capital invested. Such a situation is totally undesirable from any perspective.

Various traffic control systems have been proposed and are described in patent publications but applicant is unaware of any practical implementation thereof.

One example is given in published United States patent application number 2005/0046597 to Hutchinson et al in which there is described a traffic control system that is particularly aimed at tolerating red light running in an attempt to avoid accidents and green light extension within limits in an attempt to increase traffic flow through controlled intersections. The sensors that are used in order to achieve this are radar devices that detect vehicles and other objects within a range of up to about 1000 feet (about 300 metres) and the system detects the presence of vehicles and their speed within a predetermined field that covers the flow of traffic in one direction in an approach to an intersection.

### OBJECT OF THE INVENTION

It is an object of this invention to provide a traffic control system and method that overcomes, at least to some extent, the disadvantages associated with the prior art controllers and detection systems outlined above. It is another object of the invention to provide benefits not considered or achievable by conventional systems.

### SUMMARY OF THE INVENTION

In accordance with one aspect of this invention there is provided a traffic control system including an arrangement of traffic lights at a traffic intersection, a radar sensor installed at the intersection such that its field and range of detection cover at least one approach to the intersection and wherein the radar sensor is adapted to sense the presence of vehicles within a predetermined field of view and range, and a controller operated by an electronic processor for operating the traffic lights to regulate the flow of traffic through the intersection utilising information developed from data inputted from the radar sensor, the traffic control system being characterized in that the radar sensor is a multi-object radar sensor capable of developing data from which the location, speed and direction of travel of each vehicle within its field and range of detection can be derived and the movement of each vehicle thereby tracked within the said field and range and wherein the electronic processor provides an output for controlling the operation of the traffic lights dependent, at least to some extent, on the number of vehicles sensed within said field and range, or the length of a vehicle queue or the behavioural pattern of one or more vehicles within said field and range, or any combination thereof.

Further features of the invention provide for the multi-object radar sensor and electronic processor to be programmed to determine acceleration and deceleration of each individual vehicle within its operative field and range; for the location of each vehicle to be associated with a particular lane of the relevant approach to the intersection with different lanes optionally having different features such as their being a right or left turning lane having an influence on the control of the traffic lights, in particular any traffic lights that may be dedicated to controlling the flow of traffic in such turning lanes; for a multi-object radar sensor to be provided for each major approach to the intersection, and preferably for every approach to the intersection; and for the multi-object radar sensor to be a frequency modulated continuous wave (FMCW) radar.

Still further features of the invention provide for the controller to be a switching arrangement for switching the different coloured lights of the traffic lights; for the electronic processor to include a computer or microprocessor programmed to provide an output on the basis of computational or artificial intelligence optionally in combination with one or more appropriate algorithms; for the output to be adapted to automatically operate said controller; for a transmitter/receiver unit to be associated with the electronic processor so that data relating to one intersection can be transmitted to a central processing station that also receives similar data from other intersections with the central processing station being programmed to provide an output on the basis of computational or artificial intelligence optionally in combination with one or more appropriate algorithms in which instance the central processing station is enabled to communicate with the controller for controlling a plurality of traffic lights at a plurality of intersections with a view to controlling the flow of traffic along a comprehensive traffic route, typically major traffic routes.

In accordance with a second aspect of the invention there is provided a method of controlling a traffic light at an intersection, the method comprising sensing the presence, speed and path of travel of objects within a field and range of a multi-object radar sensor covering an approach to an intersection, processing the data generated by the multi-object radar sensor using computational or artificial intelligence optionally in combination with one or more appropriate algorithms to provide an output, and activating a controller for the traffic light on the basis of such output.

The system and method of the invention may also be used in combination with communication means associated with vehicles in various different ways.

In the first place, trains, priority vehicles and emergency vehicles may be provided with communication transmitter/receiver for transmitting information about their presence so that the operation of a traffic light can be influenced according to their location and, in the alternative, for the transmitter/receiver to be adapted to receive information as to the existing state of a traffic light located at an intersection through which it must pass. In either event, the object is to provide such a vehicle with a passage, optionally with priority, through the intersection in an extremely safe and speedy manner that avoids, for example, an emergency vehicle having to pass through a red traffic light.

In the second place, the traffic control system may thus include or be associated with transmitter means for transmitting information about the traffic situation to vehicles using dedicated short range communications (DSRC) such as radio data service (RDS), infrared and Bluetooth wireless or by way of the FMCW radar traffic sensors themselves when switched to a data transmission mode for communication with vehicles. This will allow vehicles to be able to apply evasive action should it determine that a vehicle on an opposing approach will in all likelihood not yield to the traffic lights and an accident is probable. Numerous other combinations of systems can be devised without departing from the scope of the invention.

It is to be understood that, in this specification, the term multi-object radar sensor is intended to mean a radar sensor that is capable of detecting and monitoring multiple objects within the angular field and range of the sensor such that each object can be monitored, and data generated as to its speed, acceleration or deceleration, position, and path or direction of travel within the approach to an intersection. For this purpose, the sensor is required to have at least two laterally spaced receiver antenna and suitable sensors may have more receiving antenna. The radar sensor in combination with the electronic processor is typically able to determine whether or not each vehicle is in a predetermined lane of an approach to an intersection and whether or not any particular characteristics are associated with that lane.

For the purposes of this invention, an object to be detected by the radar sensor may include any entity of interest to the flow of traffic and typically includes motorised vehicles of various classifications, animal drawn vehicles, bicycles, pedestrians, trains and trams. The multi-object radar may be a Frequency Modulated Continuous Wave (FMCW) radar and may be optimized for the monitoring of vehicles.

In order that the invention may be more fully understood an expanded description thereof follows with reference to the accompanying drawings.

### BRIEF DESCRIPTION OF THE DRAWINGS

In the drawings:

FIG. 1 is a schematic plan view of a crossroad intersection controlled by a traffic light that forms a part of one form of system according to the invention;

FIG. 2 is a schematic elevation of a traffic light and radar sensor mounted on a cantilever type of support;

FIG. 3 is a block diagram of one simple form of system according to the invention for controlling traffic lights at a single intersection;

FIG. 4 is a block diagram illustrating a more sophisticated system according to the invention in which more than one intersection is controlled by a central processing station;

FIG. 5 is a block diagram of a still more sophisticated system according to the invention in which a system of the type illustrated in FIG. 4 includes communications facilities with vehicles; and,

FIG. 6 is a schematic plan view of a crossroad intersection controlled by a traffic light incorporating control for pedestrian traffic.

### DETAILED DESCRIPTION WITH REFERENCE TO THE DRAWINGS

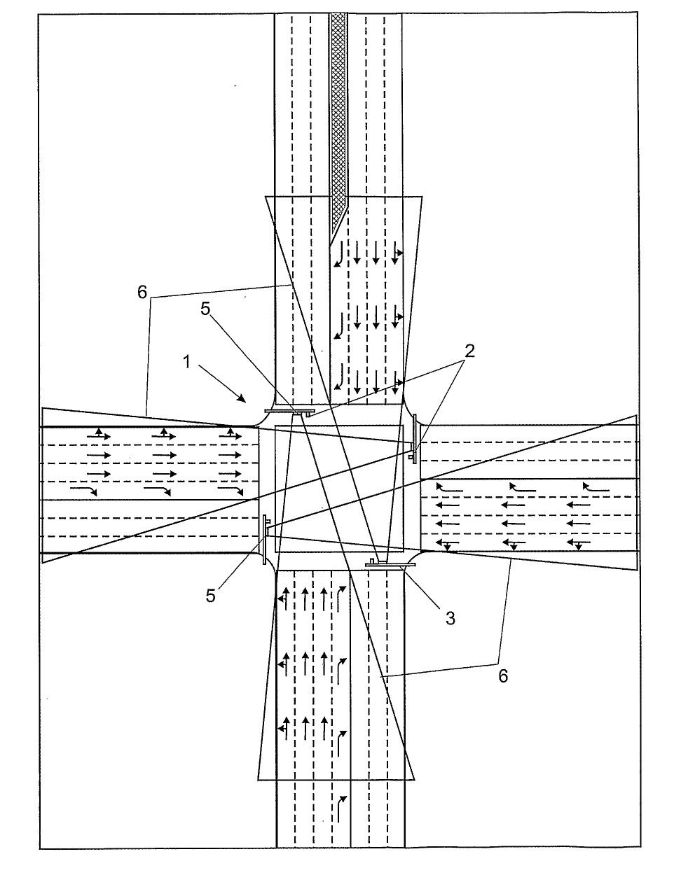

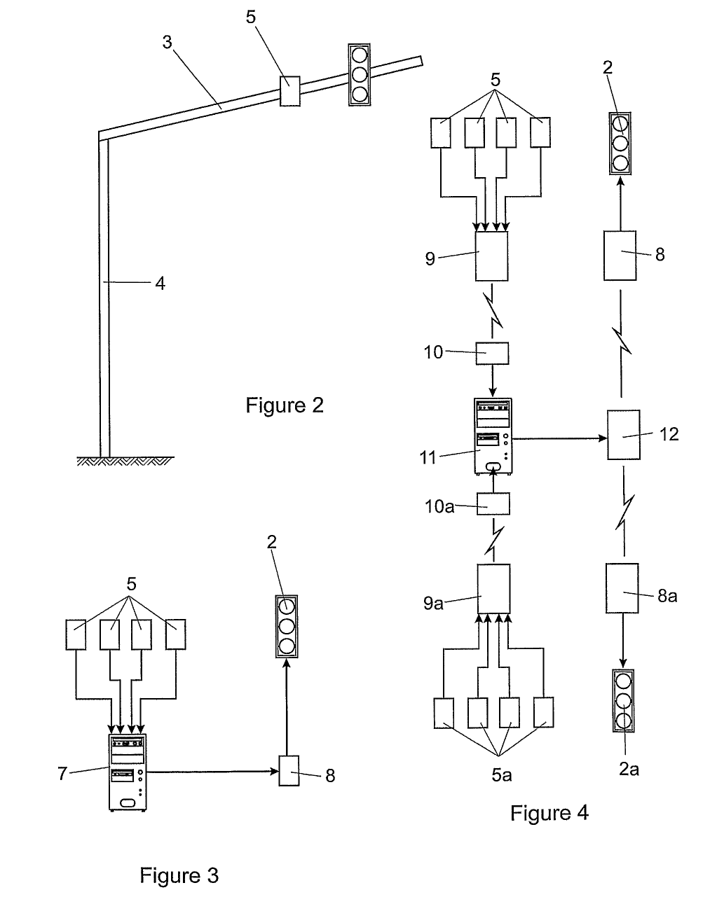

Referring firstly to FIGS. 1 and 2 of the accompanying drawings, one embodiment of the system according to the invention is applied to a simple crossroad intersection (1) controlled by the usual traffic lights (2) mounted, in this instance, on cantilever style of supports (3) carried at an upper region of a pole (4) offset laterally at one side of the road.

As provided by this invention, a multi-object radar traffic sensor (5), which in this instance is an FMCW radar, is mounted to the cantilever support (3) so that it has a predetermined range and detection area that is schematically illustrated by triangular areas indicated by numeral (6). The FMCW radar traffic sensors could be any suitable sensors and it is presently proposed to use commercially available radar sensors.

Typically, such radar sensors operate between 24 GHz and 76.5 GHz and may have up to 4 transmitting and receiving antennas. In the application of the present invention, it is essential that the position of each vehicle be capable of being determined and, this being so, an absolute minimum of two laterally spaced antenna will be required. The signal strength and phase angle is compared between the receiving antennas to yield the angle relative to boresight of each reflection from an object of interest. Typically an increasing and decreasing frequency chirp of up to 5 GHz is generated about the centre frequency which provides the means of measuring the distance to each vehicle accurately.

The Doppler shift of the received signal is also measured which provides instantaneous speed for each object according to the Doppler principle. Therefore angle, distance and speed may be measured for each object at high frequencies, typically multiple times per second such as five times a second ranging up to 20 times a second or even more. The arrangement therefore enables the movement, including acceleration, deceleration, and direction of travel of each individual vehicle to be tracked, and the behaviour of its driver to be monitored and compared to information contained in a data base.

The field of “vision” should typically be appropriate to the width of the road at the stop line and the distance between the stop line and the FMCW radar traffic sensor. Furthermore, the range may be selected according to requirements but it is envisaged that the range would typically be between 10 and 300 metres from the sensor.

There are thus up to four FMCW radar traffic sensors, one embracing the approach from each of the four directions to the intersection, as shown clearly in FIG. 1. In situations where there are more than four approaches to an intersection it should, of course, be appreciated that there may be a radar traffic sensor for each of such approaches.

The outputs from the four FMCW radar traffic sensors are fed to an electronic processor in the form of a computer or microprocessor (7) that provides an output to automatically activate a controller (8) in the form of a switching arrangement for switching the different coloured lights of the traffic lights.

The output from the computer is generated on the basis of computational or artificial intelligence optionally in combination with one or more appropriate algorithms, typically heuristic algorithms. This output is, in any event, dependent, at least to some extent, on the number of vehicles or length of a queue of vehicles or other objects, including, in appropriate instances, pedestrians, sensed within said field and range, and their speed and direction of movement as well as numerous other factors depending on the particular installation and any interaction with other similar systems at other intersections, as will be further described below. Such other factors may include, but are not limited to, object heading, the lengths of queues waiting at intersections, lane preferences of vehicles and individual vehicle behaviour.

Of course, as indicated above, the location of each vehicle may be associated with a particular lane of the relevant approach to the intersection with different lanes optionally having different features such as their being a right or left turning lane, as illustrated in FIG. 1. Vehicles detected in dedicated turning lanes may have an influence on the control of the traffic lights, in particular any traffic lights that may be specifically dedicated to the control of the flow of traffic in such turning lanes.

In the arrangement illustrated in FIG. 3, the system of the invention may be applied to a single intersection without any influence from any other system that may be installed at another intersection. In such an instance communication between the FMCW radar traffic sensors themselves and the computer could be hardwired or wireless, as may be required.

On the other hand, and as indicated in FIG. 4, the outputs from the four radar sensors could be fed to a transmitter unit (9) for wireless transmission to a receiver (10) associated with a central computerised processing station (11) that also receives data from other intersections. One such other system is indicated in FIG. 4 with the letter “a” being appended to the corresponding numerals of the components of the system.

The central processing station is programmed to provide an output for each intersection concerned on the basis of computational or artificial intelligence optionally in combination with one or more appropriate algorithms on the basis of all the inputs. The central processing station has a transmitter (12) enabled to communicate with the controller (8) of each of the intersections for controlling the traffic lights at the plurality of intersections. The aim and objective of such an arrangement would generally be the control of the flow of traffic along a comprehensive traffic route, typically a major traffic route such that it increases the quality of service and utility of the transport infrastructure network.

It is, however, foreseeable that the processing described in the above example may not be conducted at a central processing station, but rather in a decentralised configuration. Such configurations may, for example, include distributed agents, mesh configurations or grid configurations. In a mesh configuration or grid configuration each intersection may receive information from the closest other intersections to it and use this information in order to optimise the traffic at a network level. In distributed configurations on the other hand, each intersection may receive the necessary information from a central communications point in order to make decisions locally in order to optimise traffic flow at network level.

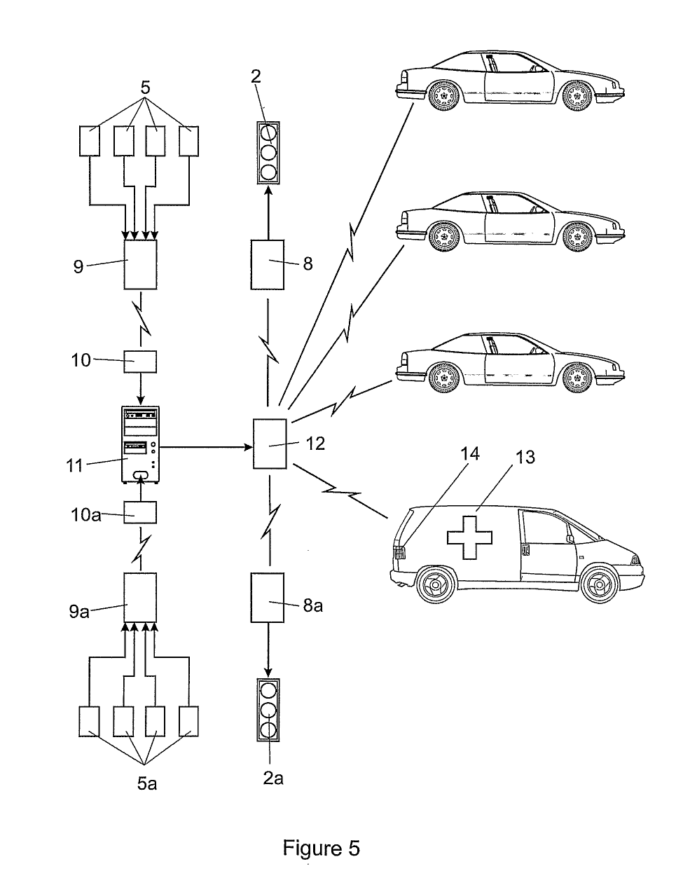

As a further extension to either the simple or more sophisticated system, and as indicated in FIG. 5 in relation to the more sophisticated system, priority vehicles such as an emergency vehicle (13) may be provided with communication transmitter/receiver (14) either for transmitting information about their presence so that the operation of a traffic light can be influenced appropriately or for receiving information from a controller or microprocessor as to the state of a traffic light on the route being travelled by the emergency vehicle. This would enable the priority vehicle to proceed through an intersection in an extremely safe and speedy manner by, for example, allowing it to pass safely through a green light that may otherwise have been red thereby avoiding it having to pass through a red traffic light all together.

In addition, the traffic control system may include transmitter means for transmitting information about the traffic situation to vehicles generally such as by way of the well-known radio data service that is currently in use in many countries, by way of SMS on the cellular telephony network or by way of the FMCW radar traffic sensors itself when switched to a data transmission mode for communication with vehicles.

From the above it will be clear that a system according to this invention is able to determine traffic conditions in the vicinity of one or more intersections and then control traffic lights such that traffic flow is optimized or such that delay or disutility is minimised through using computational intelligence with increased safety to all road users.

A single radar sensor can sense all traffic within its range and field of view and can accurately develop and yield data as to the position, speed, acceleration or deceleration, and direction of movement of every vehicle within range. The system is thus able to track the progress of each individual vehicle towards, through and away from an intersection even under congested traffic conditions. Parameters about each individual vehicle can be derived such as delay time and estimated pollution. Cumulatively such information may be used to derive statistical information pertaining to the preference of traffic such as lane preference, turning demand and deceleration profiles. All this information can be used to increase user satisfaction or the utility of the traffic control system.

In addition, the radar sensor has the capability to determine the relative sizes of objects within its sensing field. The system may therefore also be able to determine whether an object is a passenger vehicle, motor cycle, bicycle, public transport vehicle such as a bus or mini bus, or even a pedestrian.

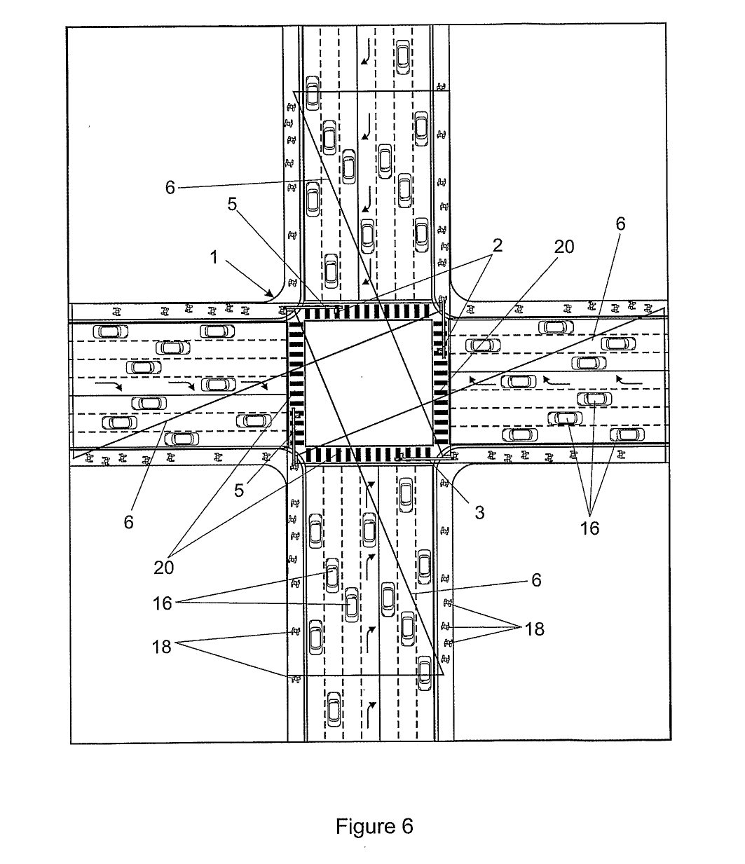

As a still further extension of the invention, and as shown in FIG. 6 in relation to a simple four-way intersection, that the system and method of the invention may also include the controlling of pedestrian traffic.

As may be seen from FIG. 6, each multi-object radar traffic sensor (5) can at any given time recognise a variety of vehicles (16) and/or pedestrians (18) within its detection area (6). As mentioned above, pedestrians may be recognised as such and their location, speed, direction of travel and potentially other appropriate parameters may be determined by the system.

The outputs of the sensors are again fed to an electronic processor which determines, in addition to the information referred to in previous examples, the number of pedestrians, if any, that are stationary at a road crossing (20). The processor may then provide an output to automatically activate control in the form of a switching arrangement for switching the different coloured lights of the traffic light, both for vehicles and pedestrians, so as to provide for safe crossing for pedestrians.

The system of the invention is equally effective under both congested and quiet traffic conditions. Improved optimization decisions can be made as a result of the fact that exact real-time dynamic attributes of all the vehicles approaching and in the intersection are available and do not have to be inferred from fallible statistical models. This information would also allow the system to anticipate collisions and control the traffic lights in order to avoid same thereby increasing the safety of road users.

A system according to this invention can thus gather data related to the traffic conditions at an intersection; process the data by applying computational and artificial intelligence and appropriate algorithms to it to make decisions regarding the control of traffic lights in such a way as to optimize a range of possible parameters related to traffic such as the throughput, delay and user satisfaction at the intersection; and use these decisions to activate the controller to change the traffic lights accordingly.

More sophisticated systems of the invention will also be able to apply control to a comprehensive route or a complete road network.

Of course, installations of this nature can be still further extended to performing law enforcement activities such as red-light and speed infringements by the addition of equipment to identify the violator (examples include automatic number plate recognising (ANPR) cameras or RF ID tag readers). In this way multiple offences attributed to a single violator may be documented and recorded into a set of moving violations over multiple intersections. Such an installation may also be used to notify motorists arriving at red traffic lights about the expected waiting time using available technologies such as a radio data service or mobile phone subscription service.

It should be appreciated that by using the described invention the flow of traffic at an intersection may be controlled in order to reduce delays experienced by a driver in order to address the shortcomings of current systems. The desired outcome is to optimise the effectiveness of an intersection through controlling the flow of traffic by taking into account many more conditions at an intersection than was possible with previous technologies and processing such information using adaptive decision making algorithms from the family of computational intelligence algorithms. This will maximise the throughput, minimise the congestion or minimise the delay.

As a result of the information that can be generated using this invention, lane change behaviour, or determination when vehicles are driving inbetween lanes such as when there is a temporary obstruction in the road can be monitored. Also as a result of the ability to determine direction of travel of each vehicle, the system of this invention is able to determine by itself where lanes are and how the road may curve as well as determining the useage of particular lanes such as turning or through lanes or both.

The system of the invention is thus able to measure individual driver behaviour.

As a result of the substantially greater quantity of information that can be derived using the invention it is therefore proposed the use of Heuristic algorithms to solve the problem of optimisation, as indicated. Artificial Intelligence has been proposed by other patents in traffic control, but they all propose methods of making decisions based on incomplete and low resolution presence detection input. The present invention proposes the use of Heuristic algorithms in order to utilize high resolution and increased data as apposed to filtering out surplus data. The present invention therefore, at least in its most developed form, considers all bits of data to contain information about the scene or state of individual vehicles and their intentions or demand. In this sense it is proposed to make use of various forms of fuzzy systems, neural networks and evolutionary computation to achieve the desired levels of utility. More specifically it is the intention to deploy swarm agents in the logic in order to simulate the chaotic base so the solution can evolve to improve the utility on the level of individual intersections, preferred corridors, arterial objectives and network wide.

The invention does not require calibration of traffic models as do other traffic control models as it can be made to the self-calibrating. Alternatively, at a time when the road is closed, it can be calibrated by driving vehicles selectively along the various lanes sequentially.

A variant on the invention may also be applied to freeway on-ramp control or optimisation.

The invention envisages a control method that is decentralised and in which each traffic controller communicates its data as well as its strategy to its neighbours. Its strategy contains a processed summary of its neighbours data. In this sense each neighbour gets its first level neighbours' traffic information plus a derivative of the second and the double derivative of it third level neighbours. Therefore the system will naturally consider the objectives of its neighbours and neighbours neighbours and so on with decreasing importance as distance increases. A feature of this configuration is that problems or exceptions or incidents will naturally propagate throughout the system and organisation of data maybe derived from the physical relationship between the nodes. In this way the system can automatically organise itself, automatically gathering data using grid paths. The key benefit of this system is that communications are much more reliable in a grid.

An extension of the control algorithm may be where the computer software calculates the disutility of each vehicle by determining the queued time for each vehicle. A queued timer may be started for each vehicle when that vehicle enters the queue. Queue entry is determined by preset parameters consisting of deceleration, speed, following distance and a spatial threshold can be added to these parameters per lane. Queue exit is determined by parameters such as acceleration, speed, distance from stop line, etc.

The system of this invention can adapt to lanes created informally by traffic during congested times such as in the creation of a temporary turn lane when a 2 lane road with a combined through/turn) is congested. Thus the present system can adapt and consider additional lanes to be input to the strategy regardless of where they form.

As a result of the fact that the invention enables vehicle progression through an intersection to be measured, travel time can then be statistically normalised and can be feed to a navigation system such as Garmin, Navteq, etc in order to predict how long a journey through congested intersections will take.

It will be understood that numerous variations may be made to the various systems described above without departing from scope hereof. In particular, it is envisaged that it may not be necessary to provide a radar sensor for every approach to an intersection as particular intersections may be primarily concerned with a single traffic parameter such as flow, delay or user satisfaction in a particular direction through the intersection.

Alternatively, it may not be necessary to provide a radar sensor for a particular minor road that enters an intersection as control could be exercised on the basis of information derived from the more important approaches to the intersection. Nevertheless it is presently considered preferable for each approach to an intersection to be monitored by a radar sensor. Of course, the number of roads entering an intersection may vary widely.

1-11. (canceled)

12. A traffic control system including an arrangement of traffic lights at a traffic intersection, a radar sensor installed at the intersection such that its field and range of detection covers at least one approach to the intersection and wherein the radar sensor is adapted to sense the presence of vehicles within a predetermined field of view and range, and a controller operated by an electronic processor for operating the traffic lights to regulate the flow of traffic through the intersection utilising information developed from data inputted from the radar sensor, wherein the radar sensor is a multi-object radar sensor capable of developing data from which the location, angle relative to boresight of the radar sensor, speed and direction of travel of each vehicle within its field and range of detection can be derived and the movement of each vehicle thereby tracked within the said field and range and wherein the electronic processor provides an output for controlling the operation of the traffic lights dependent, at least to some extent, on one or more of the number of vehicles sensed within said field and range, the length of a vehicle queue and the behavioural pattern of one or more vehicles within said field and range.

13. The traffic control system as claimed in claim 12, wherein the multi-object radar sensor and electronic processor are programmed to determine acceleration and deceleration of each individual vehicle within its operative field and range.

14. The traffic control system as claimed in claim 12, wherein the location of each vehicle is associated with a particular lane of the relevant approach to the intersection with different lanes optionally having different features.

15. The traffic control system as claimed in claim 12, wherein a multi-object radar sensor is provided for each major approach to the intersection.

16. The traffic control system as claimed in claim 15, wherein each multi-object radar sensor is a frequency modulated continuous wave (FMCW) radar.

17. The traffic control system as claimed in claim 15, wherein each multi-object radar sensor is a traffic sensor.

18. The traffic control system as claimed in claim 12, wherein the electronic processor is programmed to provide an output on the basis of computational or artificial intelligence optionally in combination with one or more appropriate algorithms.

19. The traffic control system as claimed in claim 12, wherein a transmitter unit is associated with the electronic processor so that data relating to one intersection can be transmitted to a central processing station that also receives similar data from other intersections with the central processing station being programmed to provide an output on the basis of computational or artificial intelligence optionally in combination with one or more appropriate algorithms in which instance the central processing station is enabled to communicate with the controller for controlling a plurality of traffic lights at a plurality of intersections with a view to controlling the flow of traffic along a comprehensive traffic route, typically major traffic routes.

20. The traffic control system as claimed in claim 12, wherein at least one vehicle selected from trains, trams, busses, priority vehicles and emergency vehicles is provided with a communication transmitter for transmitting information about its presence so that the operation of a traffic light can be influenced to provide such a vehicle with priority through an intersection.

21. The traffic control system as claimed in claim 12, wherein a transmitter is included for transmitting information about an existing traffic situation to vehicles using dedicated short range communications.

22. A method of controlling a traffic light at an intersection, comprising: sensing the presence, speed, angle relative to boresight and path of travel of selected objects within a field and range of a multi-object radar sensor covering an approach to an intersection, processing the data generated by the multi-object radar sensor using computational or artificial intelligence optionally in combination with one or more appropriate algorithms to provide an output, and activating a controller for the traffic light on the basis of such output.
